(19) United States
(12) Patent Application Publication
(10) Pub. No.: US 2009/0247652 A1
(43) Pub. Date: Oct. 1, 2009

(54) METAL COLLOIDS AND METHODS FOR MAKING THE SAME

(75) Inventors: Brett M. Silverman, Philadelphia, PA (US); William S. Milner, Lawrenceville, NJ (US); Bing Zhou, Cranbury, NJ (US)

Correspondence Address: Workman Nydegger;1000 Eagle Gate Tower, 60 East South Temple, Salt Lake City, UT, 84111, US

(73) Assignee: HEADWATERS TECHNOLOGY INNOVATION, LLC, Lawrenceville, NJ (US)

(21) Appl. No.: 12/056,912

(22) Filed: Mar. 27, 2008

(51) Int. Cl. B01F 17/00

(52) U.S. Cl. 516/33

(57) ABSTRACT

Colloidal suspensions of metallic particles are manufactured by providing a precursor mixture containing metallic particles having a first size, at least one solvent, and at least one stabilizing agent. The precursor mixture is sonicated to breakdown the metallic particles and suspend the particles in the solvent to form a colloid. The colloidal suspensions of metallic particles obtained with the present invention are highly concentrated and stable.

### CROSS-REFERENCE TO RELATED APPLICATIONS

Not applicable.

### BACKGROUND OF THE INVENTION

1. The Field of the Invention

The present invention relates to the manufacture of stable, highly concentrated metal colloids.

2. The Relevant Technology

The development of nanoparticles has been intensely pursued not only because of fundamental scientific interest in the particles, but also for their many technological applications. One class of nanoparticles with particularly useful characteristics is colloidal suspensions.

A colloidal suspension is a system in which particles of less than about 100 nm in size are stably suspended or dispersed in a solvent. The particles are suspended or dispersed in the solvent phase because of solvent buoyant forces that act on the particles and Brownian motion. Colloidal suspensions exhibit many useful properties. For example, colloids of magnetite, maghemite, and other magnetically responsive compounds can exhibit super paramagnetic properties. Colloids of magnetite, maghemite, and magnetite derivatives exhibit super paramagnetic properties that are useful in a broad range of applications including magnetic storage media, ferrofluids, magnetic resonance imaging (MRI) contrast agents, magnetically-guided drug delivery, medical diagnosis, alternating-current (AC) magnetic-field-assisted cancer therapy (hyperthermia).

Colloidal suspensions of are also useful as colorants and pigments and for their optical properties. For example, titanium dioxide is commonly blended into sunscreen and polymers as a UV absorber. For example, it is desirable to blend small, colloidally suspended particles of TiO₂ into sunscreen because the small particles are blended more uniformly and the small particles are able to retain their UV absorbing qualities without imparting color to a sunscreen wearer's skin.

Nanoscale colloidal particles can also be blended into a number of polymers. In the case of super paramagnetic colloids of magnetite, maghemite, and other magnetically responsive compounds, a polymer blended with a colloid will generally retain the super paramagnetic properties of the colloid. This is because of the small size of the particles and the uniformity of the colloidal suspension.

Also, because of their small size, colloidal particles can be highly reactive. For example, the high reactivity of nanoscale particles is useful in various environmental applications such as the degradation of chlorinated hydrocarbons and heavy metals in contaminated waters and soils.

### BRIEF SUMMARY OF THE INVENTION

The present invention relates to novel metallic colloidal suspensions and methods for manufacturing the same. The colloids of the present invention are prepared by starting with agglomerated or larger sized metallic particles in a slurry. The agglomerated or larger sized metallic particles are then broken down and suspended in a solvent to form a colloid. The colloid is formed by mixing the agglomerated or larger sized particles with proper stabilizing agent(s) and solvent(s) and sonicating the mixture for a period of time. The approach of the present invention uses a “top down” approach to form highly concentrated colloidal suspensions, which is in contrast to certain methods used to prepare metallic colloids where sonication is used to degrade individual molecules of a soluble metallic compound and colloidal particles are built-up from the resultant metal atoms or ions. The novel methods of the present invention can use a broad range of metallic particles, solvents, and stabilizing agents to prepare colloidal suspensions that are more concentrated and more stable than provided by previous methods.

The present invention includes a method for preparing a highly concentrated colloidal suspension of nano-scale metal particles. The method includes steps of (1) providing a precursor mixture that contains metallic particles, and (2) sonicating the precursor mixture for a time to form a colloidal suspension of metallic particles having reduced size.

The precursor mixture includes a plurality of agglomerated or larger sized metallic particles, a solvent, and a stabilizing agent. The plurality of metallic particles may be provided as a powder or slurry of individual particles or agglomerates. If the particles are provided as a powder, the powder is blended with at least one solvent to form a slurry or mixture.

The precursor mixture of the present invention may be prepared using one or more types of metallic particles. Examples of suitable metallic particles that can be included in the precursor mixture include, but are not limited to, magnetite, maghemite, cobalt ferrite, nickel ferrite, magnesium ferrite, manganese ferrite, copper ferrite, magnesium hydroxide, titanium dioxide, silicon dioxide, aluminum oxide, and combinations thereof. The metallic particles provided in the precursor mixture preferably have a size in a range from about 500 nm to about 1500 nm.

The metallic compound is typically included in the precursor mixture in a concentration range of about 1 percent to about 40 percent, by weight. More preferably, metallic compound is included in the precursor mixture in a concentration range of about 8 percent to about 30 percent, by weight.

A solvent is chosen that is compatible with the stabilizing agent and with the desired application for the colloidal suspension. For example, in one embodiment, the solvent is able to solubilize the stabilizing agent while simultaneously allowing the stabilizing agent to bond stably with the metallic particles. In terms of the desired application for the colloidal suspension, organic solvents are, for example, desirable if the colloid is going to be blended into an organic polymer while aqueous solvents are desirable for biological applications.

Examples of suitable solvents for preparing the precursor mixture include, but are not limited to, tetrahydrofuran, hexanes, ethyl acetate, water, methyl methacrylate, toluene, dimethyl formamide, phenyl ethers, propylene glycol, propylene glycol ethers, N-methylpyrrolidone, and combinations thereof.

In another embodiment of the present invention, examples of suitable solvents for preparing the precursor mixture include, but are not limited to, at least one low-boiling solvent or at least one intermediate-boiling solvent. Low-boiling solvents may be classified as solvents having a boiling point in a range from about 65° C. to about 110° C., while intermediate-boiling solvents may be classified as solvents having a boiling point in a range from about 110° C. to about 210° C. High boiling solvents can be classified as solvents having a boiling point greater than 210° C.

Examples of suitable stabilizing agents for preparing the precursor mixture include, but are not limited to, organic acids, long-chain amines, surfactants, and combinations thereof. The stabilizing agent may optionally include at least one long-chain alcohol. Preferably, the stabilizing agent comprises about 0.1 percent to about 30 percent of the precursor mixture, by weight, more preferably, about 5 percent to about 25 percent of the precursor mixture, by weight, and most preferably, about 10 percent to about 20 percent of the precursor mixture, by weight.

The process of forming the colloid according to the present invention involves sonicating the precursor mixture to break down the agglomerated or larger sized metallic particles into colloidal particles. Sonicating breaks down the particles in the precursor mixture to a size in a range from about 1 nm to about 200 nm, wherein individual particles range in size from about 1 nm to about 50 nm with the majority of agglomerates not exceeding about 200 nm.

The precursor mixture is sonicated for a period of time sufficient to break down the agglomerated or larger sized metallic particles in the precursor mixture into colloidal particles. Preferably, the precursor mixture is sonicated for about 5 minutes to about 2 hours, more preferably about 10 minutes to about 1 hour, and most preferably about 15 minutes to about 30 minutes.

According to one embodiment of the present invention, the temperature of the precursor mixture is maintained within a limited range during sonication. Preferably, the precursor mixture is sonicated at a temperature between about −25° C. and about 25° C. More preferably, the precursor mixture is sonicated at a temperature between about −15° C. and about 15° C. Most preferably, the precursor mixture is sonicated at a temperature between about −10° C. and about 10° C. Sonication at low temperature limits the agglomeration of particles and reduces the vapor pressure of the solvent.

Simultaneous with the process of breaking down the agglomerates or larger sized particles to colloidal particles, the sonicating process also acts to mix the particles with the stabilizing agent such that the agent is allowed to coat each of the particles. The stabilizing agent stabilizes the colloidal suspension by providing a layer of stabilizing agent molecules bonded to each of the metallic particles that overcomes the tendency of particles to re-agglomerate due to inter-particle attraction. The stabilizing agent also stabilizes the colloidal suspension by providing a chemical composition on the outer surface of the colloidal particles that is chemically compatible with the solvent. This further shields the particles from approaching each other and reagglomerating.

The present invention also includes a highly concentrated colloidal suspension of nano-scale metallic particles. According to one embodiment of the present invention, a highly concentrated colloidal suspension of nano-scale metallic particles includes a plurality of nano-scale metallic particles, at least one solvent that acts to suspend the particles, and at least one stabilizing agent that stabilizes the colloidal suspension of the metallic particles in the solvent. Individual particles in colloidal suspension have a size in a range from about 1 to about 50 nm, and agglomerates of individual particles have a size of less than about 200 nm. The colloids of the present invention have been made in surprisingly high concentrations of metallic particles. Concentration of the metallic particles in colloidal suspension can be in a range from about 8 percent to about 30 percent, by weight. The high concentration of stably suspended metallic particles makes the colloids useful in applications where high concentration is needed to achieve desired physical properties in a material.

These and other objects and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1A illustrates a precursor mixture;

FIG. 1B illustrates the precursor mixture of FIG. 1A during the sonication process;

FIG. 1C illustrates a colloidal suspension of nano-scale metallic particles prepared from the precursor mixture of FIG. 1A;

FIG. 2 is a schematic representation of two nano-scale colloidal particles showing a plurality of stabilizing agent molecules bonded to each particle;

FIG. 3A is a transmission electron microscopy image of colloidal nano-particles prepared according to an embodiment of the present invention;

FIG. 3B is a transmission electron microscopy image of colloidal nano-particles prepared according to an embodiment of the present invention; and

FIG. 3C is a transmission electron microscopy image of colloidal nano-particles prepared according to an embodiment of the present invention.

### DETAILED DESCRIPTION OF THE PREFERRED EMBODIMENTS

### I. Introduction

The present invention relates to novel metallic colloidal suspensions and methods for manufacturing the same. In particular, the present invention relates to colloidal suspensions of metallic particles prepared by sonication. The colloids of the present invention are prepared by starting with agglomerated or larger sized metallic particles prepared in mixtures having particularly selected stabilizing agent(s) and solvent(s). The agglomerated or larger sized metallic particles are broken down into colloidal particles by sonicating the mixture to form colloidal particles. The methods disclosed herein allow the preparation of colloidal suspensions that are highly stable and highly concentrated. The stability and high concentration colloids of the present invention make them advantageous in and of themselves, and they are advantageous for blending with other materials to makes composites.

As used herein, the term “metallic particles” refers to solid particles of elemental metal or various metallic compounds, such as oxides, nitrides, hydroxides, phosphates, halides, carbonates, and other metal derivatives.

As used herein, the term “precursor mixture” refers to a mixture of compounds used to make a colloidal suspension of metallic particles. In a minimal sense, the precursor mixture includes a plurality of metallic particles, at least one solvent, and at least on stabilizing compound. The metallic particles may be provided as a powder or a slurry.

As used herein, the term “colloid” refers to a system in which particles of between 1 nm and 1000 nm are stably suspended or dispersed in a continuous phase of a different composition.

As used herein, the “stabilizing agent” refers to a compound or mixture of compounds that are compatible with a given solvent used to form the continuous phase of a colloidal suspension and that bond to the surface of metallic particles to prevent coagulation or agglomeration of the particles in colloidal suspension by overcoming the attraction caused by inter-particle forces.

As used herein, the term “nano-scale” or “nano-sized” means a size between 1 nm and 1000 nm.

### II. Components Used to Manufacture Colloids

The following components can be used to carry out methods for manufacturing highly concentrated colloidal suspensions of metallic particles according to one embodiment of the present invention.

A. Metallic Compounds

The metallic compounds used to prepare the colloidal suspensions of the present invention are provided as powders of individual particles and/or agglomerates or as a solvent-based slurry of individual particles and/or agglomerates. Examples of suitable metal particulates that can be used in the present invention include, but are not limited to, magnetite, maghemite, cobalt ferrite, nickel ferrite, magnesium ferrite, manganese ferrite, copper ferrite, magnesium hydroxide, titanium dioxide, silicon dioxide, aluminum oxide, and combinations thereof.

Magnetite is a ferrimagnetic mineral with chemical formula Fe₃O₄. The IUPAC name for magnetite is iron(II,III) oxide and the common chemical name is ferrous-ferric oxide. The formula for magnetite may also be written as FeO.Fe₂O₃, which is one part wüstite (FeO) and one part hematite (Fe₂O₃). This refers to the different oxidation states of the iron in one structure, not a solid solution. The present invention is particularly useful for forming colloids of magnetite and other ferromagnetic materials do to the ability of the present invention to overcome the particle-particle interactions that can arise due to the magnetic properties of the material.

Maghemite (Fe₂O₃, γ-Fe₂O₃) is a member of the family of iron oxides. It has the same structure as magnetite and is also ferrimagnetic. Maghemite can be considered as an Fe(II)-deficient magnetite.

Cobalt ferrite is a cobalt containing derivative of magnetite with properties similar to those of magnetite. The formula for cobalt ferrite may be written as CoO.Fe₂O₃.

Nickel ferrite is a nickel containing derivative of magnetite with properties similar to those of magnetite. The formula for nickel ferrite may be written as NiO.Fe₂O₃.

Magnesium ferrite is a magnesium containing derivative of magnetite with properties similar to those of magnetite. The formula for magnesium ferrite may be written as MgO.Fe₂O₃.

Manganese ferrite is a manganese containing derivative of magnetite with properties similar to those of magnetite. The formula for manganese ferrite may be written as MnO.Fe₂O₃.

Copper ferrite is a copper containing derivative of magnetite with properties similar to those of magnetite. The formula for copper ferrite may be written as CuO.Fe₂O₃.

Magnesium hydroxide is an inorganic compound with the chemical formula Mg(OH)₂. Magnesium hydroxide is commonly used as a fire retardant.

Titanium dioxide, also known as titanium(IV) oxide or titania, is the naturally occurring oxide of titanium, chemical formula TiO₂. Titanium dioxide is noteworthy for its wide range of applications from paint to sunscreen to food coloring.

The chemical compound silicon dioxide is the oxide of silicon, chemical formula SiO₂. It is a principal component of most types of glass and substances such as concrete.

Aluminum oxide is an amphoteric oxide of aluminium with the chemical formula Al₂O₃. Aluminum oxide is commonly referred to as alumina or aloxite in the mining, ceramic and materials science communities. Aluminum oxide is commonly used for its abrasive and refractory properties.

B. Solvents

The solvents used to prepare the colloidal suspensions of the present invention provide a continuous phase for dispersing metallic particles of the precursor mixture and/or dispersing the colloidal-sized particles of the colloidal suspension. The solvent serves as a carrier for the metallic particles and the stabilizing agent. Various solvents or mixtures of solvents can be used, including water and organic solvents.

Solvents participate in colloid formation by transmitting sonic energy to the agglomerated or larger sized particles. Solvents also suspend the colloidal particles and provide a liquid medium for the interaction of metallic particles and stabilizing agent. In some cases, the solvent may act as a secondary stabilizing agent in combination with a primary stabilizing agent that is not acting as a solvent.

Examples of suitable solvents include, but are not limited to, tetrahydrofuran, hexanes, ethyl acetate, water, methyl methacrylate, toluene, dimethyl formamide, phenyl ethers, propylene glycol, propylene glycol ethers, N-methylpyrrolidone, and combinations thereof. The solvents of the present invention can be grouped into low-boiling and high-boiling classes. According to the present invention, a low-boiling solvent has a boiling point between about 65° C. and about 110° C. According to the present invention, an intermediate-boiling solvent has a boiling point between about 110° C. and about 210° C., and a high boiling solvent has a boiling point above 210° C.

Tetrahydrofuran, hexanes, ethyl acetate, methyl methacrylate, toluene, dimethyl formamide, phenyl ethers, propylene glycol, propylene glycol ethers, and N-methyl pyrrolidone are organic solvents with boiling points ranging from about 65° C. (tetrahydrofuran) to about 200° C. (N-methylpyrrolidone). Organic solvents are useful, for example, for blending the colloids of the present invention into polymers and for ferrofluid applications.

Water, which boils at about 100° C., is a useful solvent where the colloids of the present invention are used in biological applications. For example, water-based colloids of the present invention can be used as contrast agents in magnetic resonance imaging or as hyperthermia inducing agents in certain cancer treatments.

C. Stabilizing Agents

The stabilizing agents used to prepare the colloidal suspensions of the present invention bond to the surface of metallic particles to prevent coagulation or agglomeration of the particles in colloidal suspension by overcoming the tendency of colloidal particles to agglomerate due to inter-particle attraction. Moreover, a stabilizing agent or a mixture of agents is chosen such that it is dispersible or otherwise compatible with a given solvent used to form the continuous phase of a colloidal suspension. For example, the agent or agents can be weakly solubilized by the solvent so that the stabilizing agent is free to bond to each of the metallic particles, but the solvent does not tend to wash the molecules of stabilizing agent off of the metallic particles.

A plurality of stabilizing agent molecules are complexed with the metallic particles to control formation colloidal suspensions of the present invention. The stabilizing agent is selected to promote the formation of colloidal particles that have a desired stability, size, and/or uniformity. Examples of suitable stabilizing agents within the scope of the invention include, but are not limited to, a variety organic molecules, polymers, and oligomers. The stabilizing agent can interact and bond with the metallic particles dissolved or dispersed within an appropriate solvent or carrier through various mechanisms, including ionic bonding, covalent bonding, lone pair electron bonding, or hydrogen bonding. In at least one embodiment, the stabilizing agent is soluble in solvents comprising water and most preferably the organic stabilizing agent is water soluble.

To provide the bonding between the stabilizing agent and the metallic particles, the stabilizing agent includes one or more appropriate functional groups. Preferred stabilizing agents include functional groups which have either a charge or one or more lone pairs of electrons that can be used to complex a metal atom, or which can form other types of bonding. These functional groups allow the stabilizing agent to have a strong binding interaction with the metallic particles. In one embodiment, the functional groups of the stabilizing agent comprise one or more members selected from the group of a hydroxyl, a carboxyl, a carbonyl, an amine, an amide, a nitrile, a nitrogen with a free lone pair of electrons, an amino acid, a thiol, imidazole, phosphonic acid, phosphinic acid, a sulfonic acid, a sulfonyl halide, or an acyl halide. In one embodiment, long chain alcohols can be provided along with at least one other stabilizing agent to prevent flocculation of the metal particles in colloidal suspension.

Examples of suitable stabilizing agents include, but are not limited to, organic acids, long-chain amines, and surfactants. In addition to an organic acid, a long-chain amine, and/or a surfactant, the stabilizing agent may optionally include at least one long-chain alcohol.

Examples of suitable organic acids include so-called fatty acids. A fatty acid is an organic compound with a carboxylic acid head group and an aliphatic tail. The tail may be either saturated or unsaturated. A saturated fatty acid has no double bonds in its tail (i.e., the tail is fully saturated with hydrogen). An unsaturated fatty acid has at least one double bond in its tail (i.e., the tail is not fully saturated with hydrogen).

Examples of suitable saturated fatty acids include, but are not limited to, butanoic acid, pentanoic acid, hexanoic acid, heptanoic acid, octanoic acid, nonanoic acid, decanoic acid, undecanoic acid, dodecanoic acid, tridecanoic acid, tetradecanoic acid, pentadecanoic acid, hexadecanoic acid, heptadecanoic acid, octadecanoic acid, nonadecanoic acid, eicosanoic acid, uncosanoic acid, docosanoic acid, tricosanoic acid, and tetracosanoic acid. This series of fatty acids have tail lengths that range from four carbons to 24 carbons. In some embodiments, metal salts of the fatty acids may be used in lieu of or in addition to the carboxylic acid form.

Examples of suitable unsaturated fatty acids include, but are not limited to, undecylenic acid, myristoleic acid, palmitoleic acid, oleic acid, linoleic acid, alpha-linolenic acid, arachidonic acid, eicosapentaenoic acid, erucic acid, and docosahexaenoic acid. This series of fatty acids have tail lengths that range from 11-carbons to 24 carbons. In some embodiments, metal salts of the fatty acids may be used in lieu of or in addition to the carboxylic acid form.

Examples of suitable long-chain amines include, but are not limited to, butylamine, pentylamine, hexylamine, heptylamine, octylamine, nonylamine, decylamine, undecylamine, dodecylamine, tridecylamine, tetradecylamine, pentadecylamine, hexadecylamine, heptadecylamine, octadecylamine, nonadecylamine, eicosylamine, uncosylamine acid, docosylamine acid, tricosylamine acid, tetracosylamine, decenylamine, undecenylaamine, dodecenylamine, tridecenylamine, tetradecenylamine, pentadecenylamine, hexadecenylamine, heptadecenylamine, octadecenylamine, nonadecenylamine, eicocenylamine, uncocenylamine, dococenylamine, tricocenylamine, and tetracocenylamine.

Examples of suitable surfactants include, but are not limited to, octylphenol ethoxylates, phosphonic acids, phosphinic acids, sulfonic acids, and polyethylene glycol monoalkyl ethers. Example octylphenol ethoxylates include detergents of the well-known Triton-X series. Examples of Triton-X detergents include Triton-X 15, Triton-X 35, Triton-X 45, Triton-X 100, Triton-X 102, Triton-X 114, Triton-X 165, Triton-X 305, Triton-X 405, and Triton-X 705. Polyethylene glycol monoalkyl ethers have the general formula CH₃(CH₂)_{y}O(CH₂CH₂O)ₓH. Example polyethylene glycol monoalkyl ethers include tetraethylene glycol monooctyl ether, pentaethylene glycol monooctyl ether, hexaethylene glycol monooctyl ether, pentaethylene glycol monodecyl ether, pentaethylene glycol monodecyl ether, nonaethylene glycol monodecyl ether, octaethylene glycol monododecyl ether, nonaethylene glycol monododecyl ether, decaethylene glycol monododecyl ether, octaethylene glycol monotridecyl ether, and dodecyl glycol monodecyl ether.

Examples of suitable long-chain alcohols are organic compounds with at least one hydroxyl functional group attached to an aliphatic tail. The aliphatic tail may be unbranched or branched and the aliphatic tail may be saturated or unsaturated. Example long-chain alcohols include, but are not limited to, butanol, isobutanol, pentanol, hexanol, heptanol, octanol, nonanol, decanol, undecanol, dodecanol, tetradecanol, cetyl alcohol, stearyl alcohol, arachidyl alcohol, docosanol, octanosol, ethyl hexanol, palmitoleyl alcohol, stearyl alcohol, isostearyl alcohol, elaidyl alcohol, oleyl alcohol, linoleyl alcohol, elaidolinoleyl alcohol, linolenyl alcohol, elaidolinolenyl alcohol, ricinoleyl alcohol, arachidyl alcohol, behenyl alcohol, erucyl alcohol, lignoceryl alcohol, ceryl alcohol, montanyl alcohol, myricyl alcohol, lacceryl alcohol, geddyl alcohol, 1-hexadecanol, 1-octadecanol, 1-eicosanol, 1-docosanol, 1-tetracosanol, 1-hexacosanol, 1-octacosanol, 1-triacontanol, 1-dotriacontanol, and 1-tetratriacontanol.

### III. Manufacturing Colloidal Suspensions

The colloids of the present invention are manufactured by (1) forming a precursor mixture containing agglomerated or larger sized metallic particles having a first size, at least one solvent, and at least one stabilizing agent, and (2) sonicating the precursor mixture to break down the metallic particles to colloidal particles having a second, smaller size. In addition to breaking down the metallic particles, sonication facilitates forming a colloid by suspending the metallic particles in the solvent and allowing the metallic particles to mix with and bond to the stabilizing agent.

A. Forming a Precursor Mixture

The precursor mixture is formed by selecting one or more particulate metallic compounds, one or more appropriate solvents, and one or more appropriate stabilizing agents. The metallic compound may be provided as a powder or a slurry of individual particles or agglomerates. If the particles are provided as a powder, the powder is blended with the solvent to form a slurry.

The metallic compound or compounds are selected based on the desired properties of the resulting colloidal suspension. For example, a colloidal suspension of magnetite will possess paramagnetic and super paramagnetic properties that make it useful as a ferrofluid.

The precursor mixture of the present invention may be prepared using one or more types of metallic particles. Examples of suitable metallic powders or slurries for preparing the precursor mixture include, but are not limited to, magnetite, maghemite, cobalt ferrite, nickel ferrite, magnesium ferrite, manganese ferrite, copper ferrite, magnesium hydroxide, titanium dioxide, silicon dioxide, aluminum oxide, and combinations thereof. The metallic particles provided in the precursor mixture preferably have a size in a range from about 500 nm to about 1500 nm.

Powders or slurries of magnetite, maghemite, cobalt ferrite, nickel ferrite, magnesium ferrite, manganese ferrite, copper ferrite, magnesium hydroxide, titanium dioxide, silicon dioxide, and aluminum oxide are well-known in the art. Any method can be used to prepare the powders or slurries. In one embodiment, the powder is manufactured using methods described in Applicants' co-pending U.S. patent application entitled “Magnetite Powder and Methods of Making Same,” which has Ser. No. 11/925,147. U.S. patent application Ser. No. 11/925,147 is incorporated herein by reference in its entirety.

The metallic compound is typically included in the precursor mixture in a concentration range of about 1 percent to about 40 percent, by weight. More preferably, metallic compound is included in the precursor mixture in a concentration range of about 8 percent to about 30 percent, by weight.

First an appropriate solvent is selected. In a preferred embodiment, the solvent is a low boiling solvent or an intermediate boiling solvent, although high boiling solvents can also be used in some cases. The solvent should be chosen such that it is compatible with the desired application of the resulting colloidal suspension. Methyl methacrylate is, for example, a good choice if the colloidal suspension is going to be added to an organic polymer and aqueous solvents are useful for biological applications and composites with polar materials.

The solvent is selected such that it is compatible with the metallic compound and the stabilizing agent. For example, the solvent should be chosen so that is able to solubilize the stabilizing agent while also permitting the stabilizing agent to stably bond to the metallic particles. Moreover, the metallic particles that are coated with the stabilizing agent should be compatible with the solvent such that the colloidal particles are stably suspended in the solvent. The stabilizing agent is added in a quantity sufficient to thoroughly coat each of the metallic particles by bonding to the surface of each of the plurality of particles. Preferably, the stabilizing agent comprises between about 0.1 percent and about 30 percent of precursor mixture and the resulting colloidal suspension, by weight. More preferably, the stabilizing agent comprises between about 5 percent and about 25 percent of precursor mixture and the resulting colloidal suspension, by weight. Most preferably, the stabilizing agent comprises between about 10 percent and about 20 percent of precursor mixture and the resulting colloidal suspension, by weight.

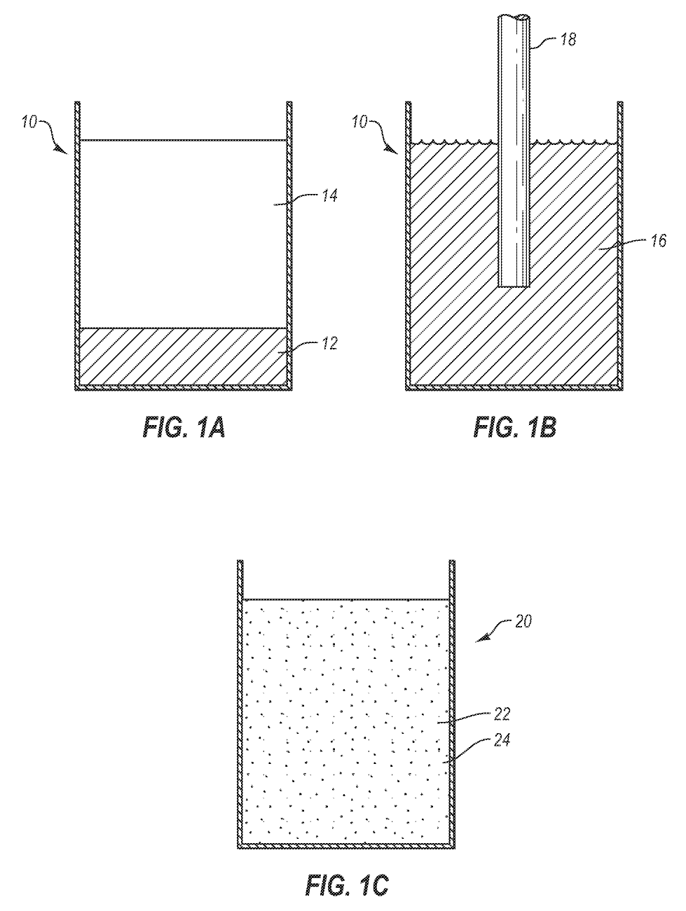

FIG. 1A depicts a schematic of an exemplary precursor mixture 10 containing a plurality of metallic particles 12 and a blend of at least one solvent and at least one stabilizing agent 14. Upon mixing the precursor mixture it is typical for the metallic particles 12 to settle because of their size, as depicted in FIG. 1A. The solvent and the stabilizing agent form layer 14.

In one embodiment, the precursor mixture can be manufactured at room temperature and atmospheric pressure. Those skilled in the art will recognize that other temperatures and pressures can be used if desired. In a preferred embodiment, the precursor mixture is stable at room temperature and pressure (e.g., stable for one or more hours).

B. Forming a Colloidal Suspension of Metallic Particles

FIG. 1B depicts a schematic of an exemplary precursor mixture 10 that is in the process of being sonicated to form a colloidal suspension of metallic particles. To form a colloidal suspension, a sonication probe 18 is inserted into the precursor mixture 10. For example, the precursor mixture can be sonicated using a 750 W, 20 kHz probe from available from Sonics, Inc. The sonication probe transmits sonic energy into the precursor mixture 10. Sonicating the precursor mixture 10 breaks down the agglomerated or larger sized metallic particles in the slurry 16 into colloidal particles. Sonicating breaks down the particles in the precursor mixture to a size in a range from about 1 nm to about 200 nm, wherein individual particles range in size from about 1 nm to about 50 nm with agglomerates not exceeding about 200 nm. Sonication carries out this process with surprising efficiency without having to resort to harsh reaction conditions, high temperature, or long reaction times.

Sonication acts to break down the metallic particles in the precursor mixture 10 to smaller, colloidal particles primarily through inducing high velocity interparticle collisions in the slurry 16 and through the formation of microbubbles that generate violent shockwaves and microjets when the bubbles collapse. The force of interparticle collisions is a function solvent type and the intensity of the sonic energy that is transmitted into the slurry 16. Bubble collapse and the forces generated therein are a function of the solvent type and the temperature of the solvent during sonication. Briefly stated, the forces generated by bubble collapse are greatest if the vapor pressure of the solvent inside the bubble is minimized. Vapor pressure is a function of solvent type and temperature. As such, it can be advantageous to sonicate at a temperature between about −25° C. and about 25° C. It is more preferable to sonicate at a temperature between about −15° C. and about 15° C. It is most preferable to sonicate at a temperature between about −10° C. and about 10° C.

The precursor mixture is sonicated for a period of time sufficient to break down the metallic particles in the precursor mixture to colloidal suspension of nano-scale particles. Preferably, the precursor mixture is sonicated for a time between about 5 minutes and about 2 hours. More preferably, the precursor mixture is sonicated for a time between about 10 minutes and about 1 hour. Most preferably, the precursor mixture is sonicated to for a time between about 15 minutes and about 30 minutes.

In one embodiment, the sonicator transmits sonic energy into the precursor mixture in a sequence of pulses. For example, a typical sonication procedure sonication procedure calls for a pulse sequence of 5 seconds on/2 seconds off. If, for example, the sample is sonicated for a total of 21 minutes, 15 minutes of which are active sonication.

The method of the present invention allows highly concentrated stable colloids to form because the solvents, stabilizing agents, particles, and sonication can be optimized for breaking down agglomerates and/or larger particles in the 500 nm to 1500 nm range. Because the particles used in the precursor mixture are already stably formed, the conditions for forming initially stable primary particle sizes is of little or no concern. This is in contrast to methods that attempt to control final particle size and particle stability in a solvent at the same time that the primary particle size is forming (i.e., as individual atoms bond together to form a crystallite or particle). By starting with agglomerated or larger particle sizes in a range from 500-1500 nm, and breaking these particles down, colloidal suspensions that are highly stable and highly concentrated can be achieved. Another advantage of starting with stable particles of 500-1500 nm is that low and intermediate-boiling solvents can be used in the process, which provides significantly different conditions and/or stabilizing agents that can be used to form colloids (compared to high-boiling solvents).

### IV. Metallic Colloids

FIG. 1C depicts a schematic of a colloidal suspension 20 prepared from the precursor mixture 10 depicted in FIGS. 1A and 1B. Through the process of sonication, the precursor mixture 10 is transformed into a stable colloidal suspension of metallic particles 20. The colloidal suspension 20 consists of a solid phase consisting of a plurality of metallic particles coated with a plurality of stabilizing agent molecules 22 and a continuous solvent phase 24. One will of course appreciate that FIG. 1C depicts a highly schematic view of the particles 22 in colloidal suspension. That is, individual particles 22 are depicted as being visible in FIG. 1C when, in reality, the particles in a colloidal suspension are much too small to be seen with the naked eye. Nonetheless, the sequence of Figures from FIG. 1A to 1C is intended to show the transformation that occurs in the mixture as a result of sonication whereby metallic particles are broken down from particles that are too large to stay in colloidal suspension 12 to particles that are small enough to be a colloid 22.

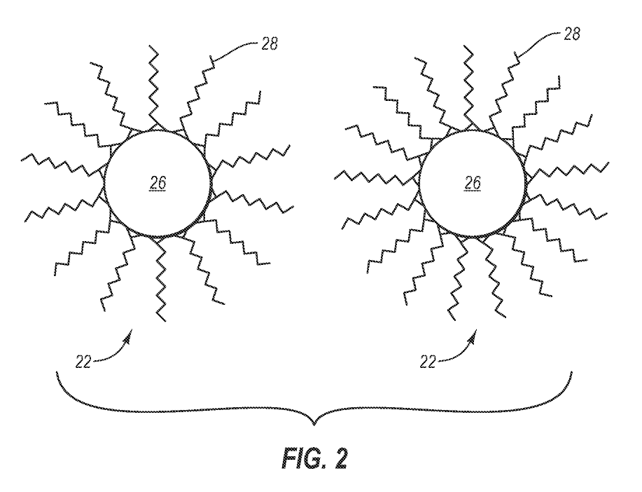

FIG. 2 depicts a schematic view of two colloidal particles coated with a plurality of stabilizing agent molecules 22. Each colloidal particle 22 consists of a metallic core particle 26 that is coated with a plurality of stabilizing agent molecules 28. The stabilizing agent molecules 28 have two major functions. The first is to prevent coagulation or agglomeration of the particles in colloidal suspension by overcoming the attraction caused by inter-particle forces. The second is to provide a chemical composition on the outer surface of the magnetic particle that is compatible with the solvent. The stabilizing agent molecules 28 coat the particles and allow solvent to flow freely amongst the colloidal particles 22. With the help of the stabilizing agent, the solvent is able to stably maintain the coated particles 22 in suspension through buoyant forces and Brownian motion.

The stabilizing agent 28 is added in a quantity sufficient to thoroughly coat the metallic particles by bonding to the surface of each of the plurality of particles. Preferably, the stabilizing agent comprises between about 0.1 percent and about 30 percent of precursor mixture and the resulting colloidal suspension, by weight. More preferably, the stabilizing agent comprises between about 5 percent and about 25 percent of precursor mixture and the resulting colloidal suspension, by weight. Most preferably, the stabilizing agent comprises between about 10 percent and about 20 percent of precursor mixture and the resulting colloidal suspension, by weight.

Colloidal suspensions of metallic particles prepared according to the present invention are surprisingly concentrated. As mentioned above, the concentration of metallic particles in the precursor mixture may be as high as 40 percent, by weight. It naturally follows that the concentration of colloidal-sized particles in the final colloidal suspension may also be as high as 40 percent, by weight. Preferably, the concentration of colloidal-sized particles in colloidal suspension following sonication is in a range of about 1 percent to about 40 percent metallic particles, by weight. More preferably, the concentration of colloidal-sized particles in colloidal suspension following sonication is in a range of about 8 percent to about 30 percent metallic particles, by weight.

The colloidal-sized particles prepared according to the present invention are present in a relatively narrow size range. As mention above, the metallic particles provided in the precursor mixture have a first size in a range from about 500 nm to about 1500 nm. In one embodiment, the particles are broken down in the process of forming the colloid to a second size in a range from about 1 nm to about 200 nm. Individual particles were observed by transmission electron microscopy to range in size from about 1 nm to about 50 nm. By light scattering, agglomerates of less than 200 nm in size were observed.

Importantly, the colloids of the present invention are highly stable. The stable particles of the present invention can remain in the colloidal suspension for days, months, or even years. The stability of the particles allows the particles to be shipped and used in many different application

In the case of colloids made from magnetically responsive materials (e.g., magnetite), the colloids manufactured according to the present invention exhibit super paramagnetic properties as a result of their small particle size.

In one embodiment of the invention, the colloids are incorporated into a composite material. The composite material is manufactured by blending the colloidal suspensions with another material such as a polymer or polymerizable material. Once the composite is formed, the solvent of the colloid can remain or can be removed to yield a final product. Examples of suitable materials that can be blended with the colloids of the present invention include polymethyl methacrylate, polyamides, polyanaline, polyethylene, polypropylene, polystyrene, poly dimethylsiloxane, latex, polybutadiene, nitrile rubber, butyl rubber, polyvinyl chloride, nylon, polyurethane, polyethylene terephthalate, polycarbonate, and combinations thereof

### V. Examples

The following examples provide formulas for making colloidal suspensions according to the present invention.

### Example 1

Example 1 describes a method for making a colloidal suspension of magnetite. The components include: 4 g Fe₃O₄, 3 ml octylamine, and 1 ml dodecyl glycol monodecyl ether. Methyl methacrylate is added to bring the total volume to 20 ml.

The components are added to the magnetite solid. The sample is then shaken to disperse the material in an elongated glass vial. The sample is placed in an ice water bath (0 degrees Celsius), and then sonicated for 15 minutes using a 750 W, 20 kHz probe from Sonics, Inc. The sonication procedure calls for a pulse sequence of 5 seconds on/2 seconds off. This makes the total elapsed time for the process to last 21 minutes, of which, 15 minutes are active sonication.

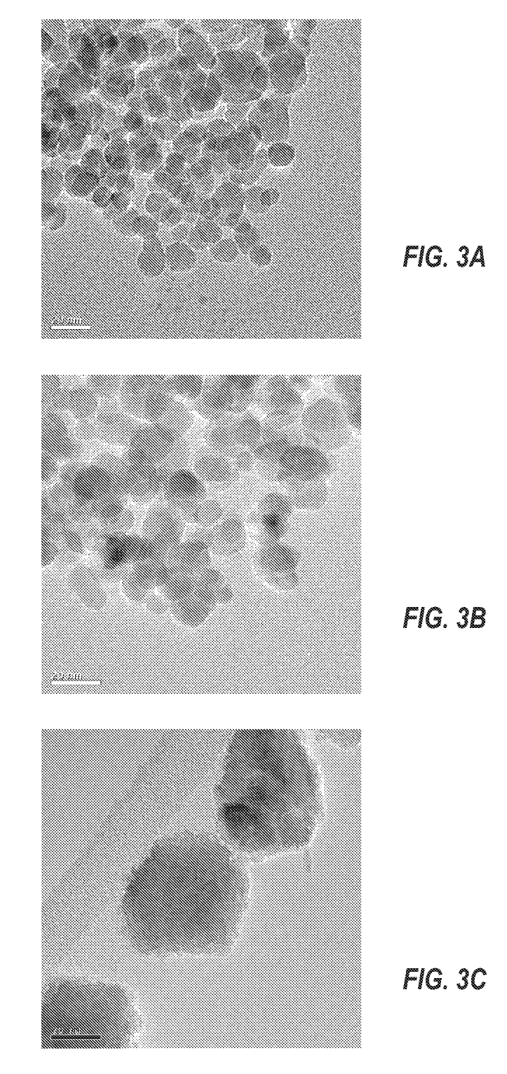

The concentration of magnetite particles in colloidal suspension in the resulting colloid is approximately 20 percent, by weight. The resulting colloid is devoid of flocculation and the magnetite particles are stably suspended in the solvent for a period of time on the order of months. The magnetite particles have a laser scattering particle size of less that 200 nm and a TEM particle size between about 5 nm and about 30 nm. A transmission electron microscope (TEM) image showing magnetite particles made according to Example 1 can be seen in FIG. 3A.

### Example 2

Example 2 describes an alternate method for making a colloidal suspension of magnetite. The components include: 4 g Fe₃O₄, 1.24 ml undecylenic acid, 1.12 decanoic acid, and 1.64 hexanoic acid. Methyl methacrylate is added to bring the total volume to 20 ml.

The components are added to the magnetite solid. The sample is then shaken to disperse the material in an elongated glass vial. The sample is placed in an ice water bath (0° C.), and then sonicated for 15 minutes using a 750 W, 20 kHz probe from Sonics, Inc. The sonication procedure calls for a pulse sequence of 5 seconds on/2 seconds off. This makes the total elapsed time for the process to last 21 minutes, of which, 15 minutes are active sonication.

The concentration of magnetite particles in colloidal suspension in the resulting colloid is approximately 20 percent, by weight. The resulting colloid is devoid of flocculation and the magnetite particles are stably suspended in the solvent for a period of time on the order of months. The magnetite particles have a laser scattering particle size of less that 200 nm and a TEM particle size between about 5 nm and about 30 nm. A TEM image showing magnetite particles made according to Example 2 can be seen in FIG. 3B.

### Example 3

Example 3 describes another method for making a colloidal suspension of magnetite. The components include: 4 g Fe₃O₄, 2 ml butyric acid, and 1 g oleic acid sodium salt. Deionized water is added to bring the total volume to 20 ml.

The components are added to the magnetite solid. The sample is then shaken to disperse the material in an elongated glass vial. The sample is placed in an ice water bath (0 degrees Celsius), and then sonicated for 15 minutes using a 750 W, 20 kHz probe from Sonics, Inc. The sonication procedure calls for a pulse sequence of 5 seconds on/2 seconds off. This makes the total elapsed time for the process to last 21 minutes, of which, 15 minutes are active sonication.

The concentration of magnetite particles in colloidal suspension in the resulting colloid is approximately 20 percent, by weight. The resulting colloid is devoid of flocculation and the magnetite particles are stably suspended in the solvent for a period of time on the order of months. The magnetite particles have a laser scattering particle size of less that 200 nm and a TEM particle size between about 5 nm and about 40 nm. A (TEM) image showing magnetite particles made according to Example 3 can be seen in FIG. 3C.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method of preparing a highly concentrated colloidal suspension of nano-scale metal particles, comprising:
providing a precursor mixture comprised of,
a plurality of agglomerated particles and/or metallic particles having a first size, the particles being provided as a powder or slurry of individual particles or agglomerates;
a solvent; and
a stabilizing agent comprised of a plurality of molecules which are dispersible in the solvent and are capable of stably bonding to the powdered metallic substance; and
sonicating the precursor mixture for a time to form a colloidal suspension of smaller sized metallic particles having a second size in a range from about 1 nm to about 200 nm.

2. A method as recited in claim 1, wherein concentration of the metallic particles in the colloidal suspension is in a range of about 8 percent to about 30 percent, by weight.

3. A method as recited in claim 1, wherein the first size is in a range of about 500 nm to about 1500 nm.

4. A method as recited in claim 1, wherein individual metallic particles in the colloidal suspension have a size in a range from about 1 to about 50 nm, and wherein agglomerates of individual particles in the colloidal suspension have a size of less than about 200 nm.

5. A method as recited in claim 1, wherein the powdered metallic substance is chosen from the group consisting of magnetite, maghemite, cobalt ferrite, nickel ferrite, magnesium ferrite, manganese ferrite, copper ferrite, magnesium hydroxide, titanium dioxide, silicon dioxide, aluminum oxide, and combinations thereof.

6. A method as recited in claim 1, wherein the solvent is chosen from the group consisting of tetrahydrofuran, hexanes, ethyl acetate, water, methyl methacrylate, toluene, dimethyl formamide, phenyl ethers, propylene glycol, propylene glycol ethers, N-methylpyrrolidone, and combinations thereof.

7. A method as recited in claim 1, wherein at least one solvent is a low boiling solvent with a boiling point in a range from about 65° C. to about 110° C.

8. A method as recited in claim 1, wherein at least one solvent is a intermediate-boiling solvent with a boiling point in a range from about 110° C. to about 210° C.

9. A method as recited in claim 1, wherein the stabilizing agent comprises at least one of an organic acid, a long-chain amine, or a surfactant, and optionally includes one or more long-chain alcohols.

10. A method as recited in claim 9, wherein the organic acid is a fatty acid chosen from the group consisting of butanoic acid, pentanoic acid, hexanoic acid, heptanoic acid, octanoic acid, nonanoic acid, decanoic acid, undecanoic acid, dodecanoic acid, tridecanoic acid, tetradecanoic acid, pentadecanoic acid, hexadecanoic acid, heptadecanoic acid, octadecanoic acid, nonadecanoic acid, eicosanoic acid, uncosanoic acid, docosanoic acid, tricosanoic acid, tetracosanoic acid, undecylenic acid, myristoleic acid, palmitoleic acid, oleic acid, linoleic acid, alpha-linolenic acid, arachidonic acid, eicosapentaenoic acid, erucic acid, docosahexaenoic acid, and metals salts thereof.

11. A method as recited in claim 9, wherein the stabilizing agent includes at least one long-chain amine with a chain length of at least 6 carbon atoms.

12. A method as recited in claim 9, wherein the surfactant is chosen from the group consisting of octylphenol ethoxylates, phosphonic acids, phosphinic acids, sulfonic acids, polyethylene glycol monoalkyl ethers, and combinations thereof.

13. A method as recited in claim 1, further comprising sonicating at a temperature in the range of about −25° C. to about 25° C.

14. A method as recited in claim 1, further comprising sonicating at a temperature in the range about −10° C. to about 10° C.

15. A highly concentrated colloidal suspension comprising a plurality of nano-scale metallic particles prepared according to the method of claim 1.

16. A method of preparing a highly concentrated colloidal suspension of a nano-scale metal particles, comprising:
providing a precursor mixture comprised of,
a plurality of agglomerated particles or metallic particles having a first size in a range from about 500 nm to about 1500 nm, the particles being provided as a powder or slurry of individual particles or agglomerates;
at least one solvent chosen from the group consisting of tetrahydrofuran, hexanes, ethyl acetate, water, methyl methacrylate, toluene, dimethyl formamide, phenyl ethers, propylene glycol, propylene glycol ethers, N-methylpyrrolidone, and combinations thereof; and
a stabilizing agent comprised of a plurality of molecules that are compatible with the solvent and are capable of bonding to the plurality of metallic particles; and
sonicating the precursor mixture at a temperature between −25° C. and 25° C., for a time in a range from about 5 minutes to about 2 hours, wherein the sonicating suspends the plurality of metallic particles in the solvent, allows the stabilizing agent to bond to the plurality of metallic particles, and disrupts or breaks down the plurality of metallic particles and/or agglomerates thereof to form a colloidal suspension of smaller metallic particles having a second size in a range from about 1 nm to about 200 nm, and wherein the colloidal suspension of metallic particles has a concentration in a range of about 8 percent to about 30 percent, by weight.

17. A method as recited in claim 16, wherein individual metallic particles in the colloidal suspension have a size in a range from about 1 to about 50 nm, and wherein agglomerates of individual particles in the colloidal suspension have a size of less than about 200 nm.

18. A method as recited in claim 16, wherein the powdered metallic substance is chosen from the group consisting of magnetite, maghemite, cobalt ferrite, nickel ferrite, magnesium ferrite, manganese ferrite, copper ferrite, magnesium hydroxide, titanium dioxide, silicon dioxide, aluminum oxide, and combinations thereof.

19. A method as recited in claim 16, wherein the at least one solvent is a low boiling solvent with a boiling point in a range from about 65° C. to about 110° C.

20. A method as recited in claim 16, wherein the at least one solvent is an intermediate-boiling solvent with a boiling point in a range from about 110° C. to about 210° C.

21. A method as recited in claim 16, wherein the stabilizing agent comprises at least one of:
a saturated fatty acid having an aliphatic chain length between 4 and 22 carbon atoms, and metal salts thereof;
a long-chain amine having an aliphatic chain length of at least 4 carbon atoms; or
a surfactant chosen from the group consisting of octylphenol ethoxylates, phosphonic acids, phosphinic acids, sulfonic acids, and combinations thereof; and
optionally includes at least one long-chain alcohol having an aliphatic chain length of at least 4 carbon atoms.

22. A highly concentrated colloidal suspension comprising a plurality of nano-scale metallic particles prepared according to the method of claim 16.

23. A highly concentrated colloidal suspension of nano-scale metal particles, comprising:
at least one solvent;
a plurality of nano-scale metallic particles dispersed in the solvent, the metallic particles comprising about 8 weight-percent to about 30 weight-percent of the colloidal suspension, wherein the primary particle size of the metallic particles is in a range from about 1.0 nm to about 50 nm, and agglomerates of the metallic particles have a size of less than about 200 nm;
at least one stabilizing agent bonded to each of the plurality of nano-scale metallic particles and suspending the metallic particles in the solvent, wherein the stabilizing agent comprises at least one of an organic acid, a long-chain amine, or a surfactant, and optionally includes at least one long-chain alcohol.

24. A colloid as in claim 23, wherein the plurality of nano-scale metallic particles are chosen from the group consisting of magnetite, maghemite, cobalt ferrite, nickel ferrite, magnesium ferrite, manganese ferrite, copper ferrite, magnesium hydroxide, titanium dioxide, silicon dioxide, aluminum oxide, and combinations thereof.

25. A colloid as in claim 23, wherein the at least one solvent chosen from the group consisting of tetrahydrofuran, hexanes, ethyl acetate, water, methyl methacrylate, toluene, dimethyl formamide, phenyl ethers, propylene glycol, propylene glycol ethers, N-methylpyrrolidone, and combinations thereof.

26. A composite material manufactured by blending the colloid of claim 23 with a material to yield the composite.
